(19) United States
(12) Patent Application Publication
(10) Pub. No.: US 2025/0096670 A1
(43) Pub. Date: Mar. 20, 2025

(54) POWER CONVERSION DEVICE

(71) Applicant: HITACHI ASTEMO, LTD., Hitachinaka-shi, Ibaraki (JP)

(72) Inventors: Shoya AWAMORI, Hitachinaka-shi, Ibaraki (JP); Kenichiro NAKAJIMA, Hitachinaka-shi, Ibaraki (JP); Yuta NUMAKURA, Hitachinaka-shi, Ibaraki (JP); Ryota SHOJI, Hitachinaka-shi, Ibaraki (JP)

(73) Assignee: HITACHI ASTEMO, LTD., Hitachinaka-shi, Ibaraki (JP)

(21) Appl. No.: 18/729,342

(22) PCT Filed: Feb. 22, 2022
(86) PCT No.: PCT/JP2022/007424

§ 371 Date: Jul. 16, 2024

(51) Int. Cl. H02M 1/32; H02M 1/14; H02M 1/44; H02M 7/00; H02M 7/537

(52) U.S. Cl. CPC H02M 1/327; H02M 1/14; H02M 1/44; H02M 7/003; H02M 7/537

(57) ABSTRACT

A power conversion device is equipped with a power module having a semiconductor device that converts DC power into AC power and a cooling passage that cools the semiconductor device, the power conversion device including a metal accommodating member a bottom surface of which is thermally connected to the cooling passage via a heat conduction member, wherein the accommodating member accommodates a plurality of smoothing capacitors for smoothing the DC power, and the plurality of smoothing capacitors are electrically connected to the semiconductor device via a DC busbar that is connected to the semiconductor device and that inputs the DC power to the semiconductor device.

### TECHNICAL FIELD

The present invention relates to a power conversion device.

### BACKGROUND ART

In power conversion device design, there is the concept of component standardization which, by combining a plurality of standard components, compensates for differences between the specifications of the components. However, assembly by incorporating a plurality of components in a device yields an assemblability which is inferior to incorporation of a single component. In addition, cooling of heat generated at the time of driving is a problem in a power conversion device that is required to have a high output and a small size. In view of these points, complication of the internal structure of the device hinders appropriate heat dissipation of each part, which may lead to deterioration of the components and shortening of the life thereof due to heat, and thus is related to a reduction in reliability. Therefore, there is a demand for a device that enables assemblability to be maintained while simplifying the internal structure.

PTL 1 below discloses a configuration in which a cooling passage is arranged on both surfaces of a power module, and a capacitor unit 23 is disposed on a heat dissipation surface of the passage on a side opposite to the power module to dissipate heat, thereby improving cooling efficiency.

### CITATION LIST

### Patent Literature

PTL 1: JP 2019-161797 A

### SUMMARY OF INVENTION

### Technical Problem

In PTL 1, although an improvement in cooling efficiency and suppression of device enlargement can be expected, attachment of the capacitor unit is not specifically specified, and the problem of device assemblability persists. In view of this problem, an object of the present invention is to provide a power conversion device that achieves both an improvement in assemblability and maintenance of device heat dissipation.

### Solution to Problem

A power conversion device is equipped with a power module having a semiconductor device that converts DC power into AC power and a cooling passage that cools the semiconductor device, the power conversion device including a metal accommodating member a bottom surface of which is thermally connected to the cooling passage via a heat conduction member, wherein the accommodating member accommodates a plurality of smoothing capacitors for smoothing the DC power, and the plurality of smoothing capacitors are electrically connected to the semiconductor device via a DC busbar that is connected to the semiconductor device and that inputs the DC power to the semiconductor device.

### Advantageous Effects of Invention

It is possible to provide a power conversion device that achieves both an improvement in assemblability and maintenance of device heat dissipation.

### BRIEF DESCRIPTION OF DRAWINGS

FIG. 1 is an overall exploded structural diagram of a power conversion device.

FIG. 2 is an exploded structural view in which a portion of the components, such as the power module in FIG. 1, is accommodated in a housing.

FIG. 3 is a diagram illustrating the interior of the housing accommodating a portion of the components such as a second DC busbar and a power module.

FIG. 4 is a diagram illustrating the units of a DC circuit module.

FIG. 5 is a diagram illustrating a noise filter.

FIG. 6 is a diagram illustrating two DC busbars according to an embodiment of the present invention.

FIG. 7 is a diagram of two DC busbars in FIG. 6 as viewed from a direction B.

FIG. 8 is a diagram of the DC circuit storage member in FIG. 4 as viewed from a direction A.

FIG. 9 is a cross-sectional view of a power conversion device according to an embodiment of the present invention.

FIG. 10 is a diagram of the components housed in the DC circuit storage member as viewed from an upper opening direction.

FIG. 11 is a diagram illustrating a simplified structure of a cross-sectional view of the power conversion device in FIG. 9 according to an embodiment of the present invention.

FIG. 12 is an electric circuit diagram of the power conversion device.

FIG. 13 is a first modification.

FIG. 14 is a second modification.

Hereinafter, embodiments of the present invention will be described with reference to the drawings. The following description and drawings are examples to illustrate the present invention and, where appropriate, are omitted and simplified for the sake of clarity in the description. The present invention can be carried out in various other forms. Unless otherwise specified, each constituent element may be singular or plural.

The positions, sizes, shapes, ranges, and the like of the constituent elements illustrated in the drawings may not represent actual positions, sizes, shapes, ranges, and the like in order to facilitate understanding of the invention. Therefore, the present invention is not necessarily limited to or by the positions, sizes, shapes, ranges, and the like disclosed in the drawings.

### One Embodiment and Overall Configuration

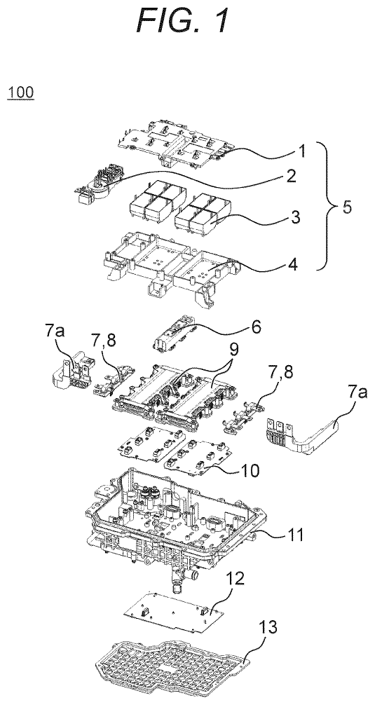

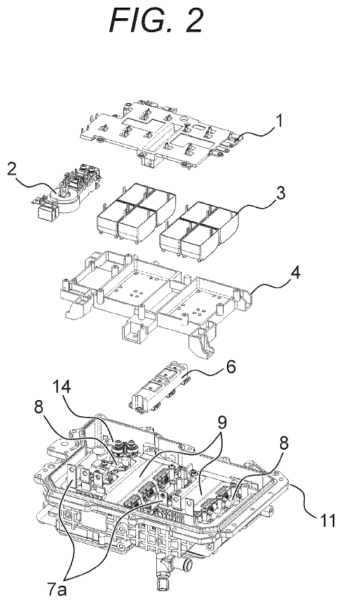

### (FIGS. 1 and 2)

A power conversion device 100 (hereinafter, referred to as the inverter 100) includes a first DC busbar 1, an EMC (Electromagnetic Compatibility) filter 2, a smoothing capacitor 3, a DC circuit storage member 4 (hereinafter, referred to as the case 4), a second DC busbar 6, an AC busbar 7, an L-shaped AC busbar 7a (hereinafter, referred to as an L-shaped AC busbar 7a), an AC sensor 8, a power module unit 9 (hereinafter, referred to as a power module 9), and a gate drive substrate 10 housed inside a housing 11. The MC (Motor Control) substrate 12 is disposed on the housing 11 on the side opposite to the opening side for accommodating the above internal components (on the outer side of the bottom portion). The cover 13 is disposed on the outer side of the bottom portion of the housing 11 so as to cover the MC substrate 12, thereby protecting the MC substrate 12.

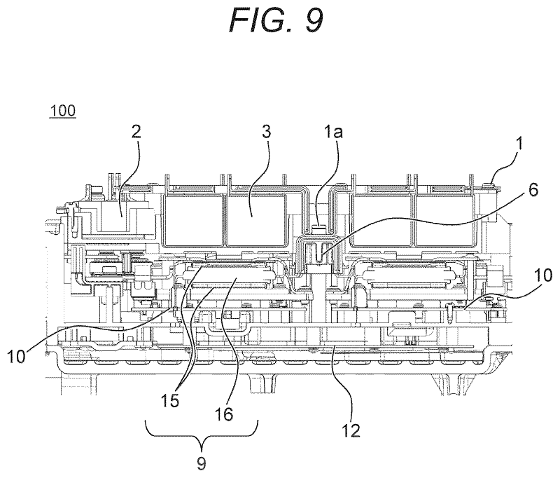

The housing 11 is formed of a metal such as aluminum or iron, and can be formed by casting such as aluminum die casting, for example. The housing 11 has a bottom portion and is formed in a box shape with an open top. The housing 11 not only houses the components of the inverter 100 but also has a function as a cooling passage formation body to allow a refrigerant for cooling the power module 9 to flow throughout the housing 11. As a result, the refrigerant supplied from the outside of the housing 11 flows, via a passage formed in the housing 11, to a cooling passage 15 (described below in FIG. 9) provided in the power module 9, and cools a semiconductor device 16 (described below in FIG. 9). In addition, the housing 11 is connected at the same potential as ground potential via an assembled component.

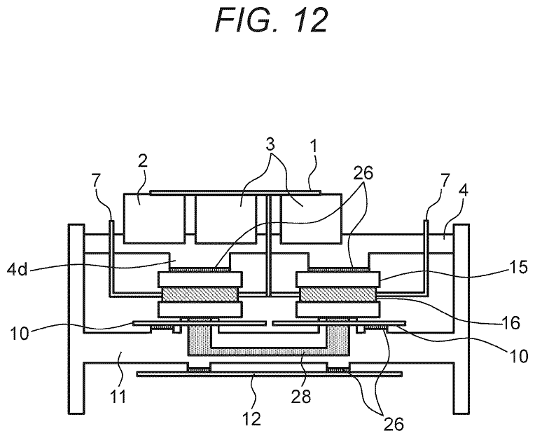

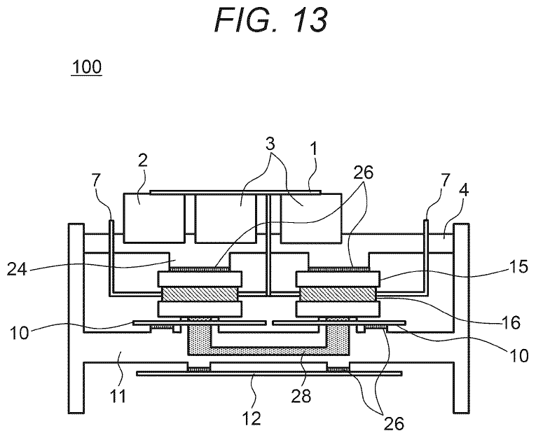

The MC substrate 12 is an electronic control board that is connected to the inverter 100 and controls the operation of a motor (described below with reference to FIG. 12) driven by AC power. The MC substrate 12 is disposed facing the power module 9 with a bottom portion of the housing 11 interposed therebetween, and is thermally connected to the housing 11 via a heat conduction member 26 (described below with reference to FIG. 13). As a result, it is to be expected that the cooling performance of the MC substrate 12 is secured and the noise resistance is improved, which can contribute to improving the reliability of the inverter 100.

The first DC busbar 1, the EMC filter 2, the smoothing capacitor 3, and the case 4 are unitized and function as a DC circuit module 5 (hereinafter referred to as a DC circuit body 5). The L-shaped AC busbar 7a is an AC busbar formed in an L-shape along the inner wall of the housing 11.

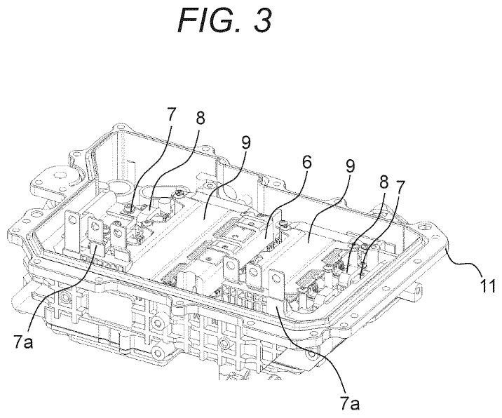

### (FIG. 3)

The AC busbar 7 is electrically connected to an AC power input/output unit (not illustrated) of the power module 9. Although the AC busbar 7 and the power module 9 are connected by welding, other connection methods may be used. The second DC busbar 6 is connected to a DC power input/output unit (not illustrated) of the power module 9. The AC busbar 7 is disposed in a position facing the second DC busbar 6 with the power module 9 interposed therebetween.

In addition, the AC current sensor 8 has a circular shape in which the center portion penetrates, and is arranged such that the AC busbar 7 penetrates the center portion of the AC current sensor 8 in order to measure the current flowing through the AC busbar 7. The AC busbar 7 is connected to the L-shaped AC busbar 7a. Although a screw fastening method is used for this connection, the connection need not be limited to this connection method. Furthermore, the illustrated number of components may not be limited thereto.

The L-shaped AC busbar 7a is collected at one end on the long side of the housing 11 and protrudes (extends) in the upper direction. The AC busbar 7a is connected, via a section thereof extending in the upper direction, to a motor (not illustrated), but this connection does not affect the position in which same is connected to the motor.

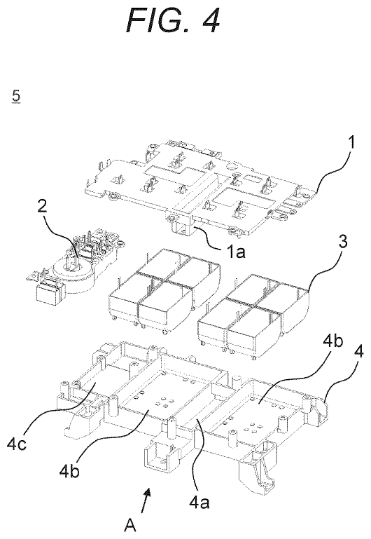

### (FIG. 4)

The case 4, which is a metal accommodating member, accommodates a plurality of smoothing capacitors 3 that form a DC circuit and smooth DC power, an EMC filter (noise filter) 2 that removes radio frequency noise from the DC power, and a first DC busbar 1 that electrically connects the plurality of smoothing capacitors 3 and the EMC filter 2. By being accommodated in the case 4, the first DC busbar 1, the EMC filter 2, and the plurality of smoothing capacitors 3 function as the DC circuit body 5 in an integrated manner (as a unit).

The case 4 is an accommodating member that includes smoothing capacitor accommodating portions 4b that two accommodate the plurality of smoothing capacitors 3, and a filter accommodating portion 4c that accommodates the EMC filter 2 constituting the noise filter circuit. The same number of capacitors 3 are each accommodated in the two smoothing capacitor accommodating portions 4b.

The first DC busbar 1 is connected to the EMC filter 2 and the smoothing capacitor 3 accommodated in the case 4. The first DC busbar 1 has a protrusion 1a formed in a downward-protruding shape. In the case 4, among the two smoothing capacitor accommodating portions 4b, assuming that the smoothing capacitor accommodating portion 4b on the left side of FIG. 4 is a first smoothing capacitor accommodating portion and the smoothing capacitor accommodating portion 4b on the right side of FIG. 4 is a second smoothing capacitor accommodating portion, a pit portion 4a is provided between the first smoothing capacitor accommodating portion 4b and the second smoothing capacitor accommodating portion 4b, and the first smoothing capacitor accommodating portion 4b and the second smoothing capacitor accommodating portion 4b are each arranged with the pit portion 4a interposed therebetween. The pit portion 4a has a penetrating structure so that the protrusion 1a of the first DC busbar 1 can be connected to the second DC busbar 6.

The case 4 is connected to the housing 11 and thus has the same potential as ground potential. Therefore, the case 4 serves as ground earthing for the EMC filter 2, and also serves, in the power module 9 that performs switching driving, as a shielding shield for electromagnetic noise generated at the time of switching.

In this manner, by unitizing and accommodating the smoothing capacitor 3 and the EMC filter 2 in the case 4, even in a case where the smoothing capacitor 3 and the EMC filter 2 are individually componentized by using capacitors (cluster CAP) assembled in a cluster shape, it is possible to arrange the smoothing capacitor 3 and the EMC filter 2 without impairing the assemblability only by installing the case 4.

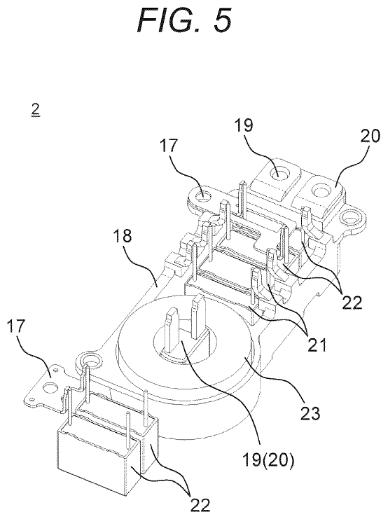

The number of the smoothing capacitors 3 for the smoothing capacitor accommodating portion 4b is not limited to four as illustrated in FIG. 4. In addition, the number of elements of the filter capacitors 21 and 22 (described below in FIG. 5) mounted on the EMC filter 2 side may be reduced, and the number of the smoothing capacitors 3 accommodated may be increased. In addition, by reducing the number of elements of the filter capacitors 21 and 22, the length from the pit portion 4a to the EMC filter 2 (or the filter accommodating portion 4c) may be reduced in the case 4 to reduce the space required for accommodation. The smoothing capacitors 3 are connected to the first DC busbar 1 by welding, but this connection may be another method such as a caulking connection or screw fastening.

As long as the EMC filter 2 and the smoothing capacitors 3 can be mounted, the case 4 is not limited to a bag-like structure such as the accommodating portions 4b and 4c as illustrated in FIG. 4, and may have a plate shape, for example.

### (FIG. 5)

The EMC filter 2 includes a first filter capacitor 21, a second filter capacitor 22, a core member 23, and a molded busbar 18. The EMC filter 2 is provided between a high-voltage battery 101 (described below in FIG. 12) and the smoothing capacitors 3, and suppresses electromagnetic noise generated at the time of a power conversion operation (at the time of switching) of the power module 9.

The EMC filter 2 is connected to the first DC busbar 1. Although this connection is a welding connection, the present invention is not limited thereto, and other methods such as a caulking connection or screw fastening may be used.

The EMC filter 2 includes a positive electrode busbar 19 and a negative electrode busbar 20, which are DC busbars for transmitting DC power. The first filter capacitor 21 has one end electrically connected to the positive electrode busbar 19 and the other end electrically connected to the negative electrode busbar 20. The second filter capacitor 22 has one end electrically connected to one of the positive electrode busbar 19 and the negative electrode busbar 20, and the other end electrically connected to a grounding busbar 17 for grounding to ground potential.

The core member 23 is made of a magnetic material, and absorbs electromagnetic noise of current flowing through the busbars 19 and 20 of the EMC filter 2. The core member 23 has a hollow cylindrical shape, and the positive electrode busbar 19 and the negative electrode busbar 20, which are circuit portions of the EMC filter 2, pass through the center through-hole. Therefore, the core member 23 is disposed so as to surround the two DC busbars 19 and 20. In the present embodiment, the core member 23 can be stored in the filter accommodating portion 4c by matching the shape of the core member 23 and the shape of the resin constituting the molded busbar 18, but the method for installing the core member 23 is not limited to such a method.

The positive electrode busbar 19 and the negative electrode busbar 20 electrically connect the high-voltage battery 101 and the power module 9. The positive electrode busbar 19 and the negative electrode busbar 20 include a terminal portion for electrically connecting the first filter capacitor 21 and the second filter capacitor 22. Although the positive electrode busbar 19, the negative electrode busbar 20, the first filter capacitor 21, and the second filter capacitor 22 are connected by welding in the present embodiment, other methods such as a caulking connection or screw fastening may be used.

The grounding busbar 17 is connected to one terminal of the second filter capacitor 22. The grounding busbar 17 is fixed to the case 4 by screw fastening, and is electrically connected to the same potential as ground potential via the housing 11 fastened to the case 4. The connection position between the grounding busbar 17 and the case 4 is preferably as close as possible to the fastening position between the case 4 and the housing 11 from the viewpoint of noise resistance. The grounding busbar 17 may also be directly connected to the housing 11 instead of being indirectly connected to the housing 11 via the case 4.

Because the EMC filter 2 is accommodated in the case 4, which is thermally connected to the cooling passage 15 of the power module 9, heat can be moved via the resin member which fills the gap between the EMC filter 2 and the case, and hence heat dissipation can be improved, which contributes to the reliability of the device 100.

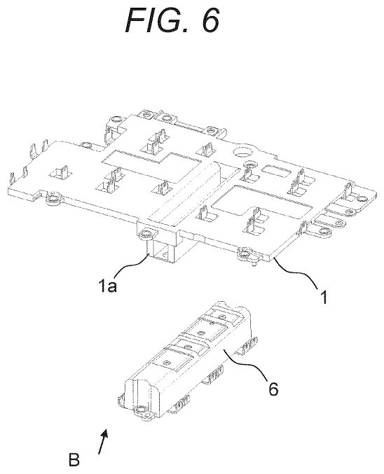

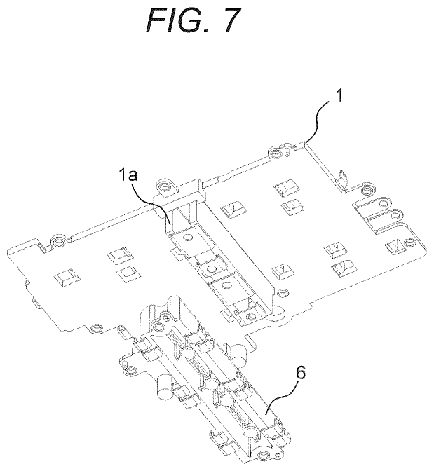

### (FIGS. 6 and 7)

The two DC busbars 1 and 6 will be described. The first DC busbar 1 is electrically connected to the second DC busbar 6 via the protrusion 1a. Accordingly, the EMC filter 2 and the smoothing capacitors 3 accommodated in the case 4 are electrically connected to the power module 9. In the present embodiment, this connection is a connection by screw fastening, but the present invention is not limited thereto, rather, other methods such as a caulking connection may also be used.

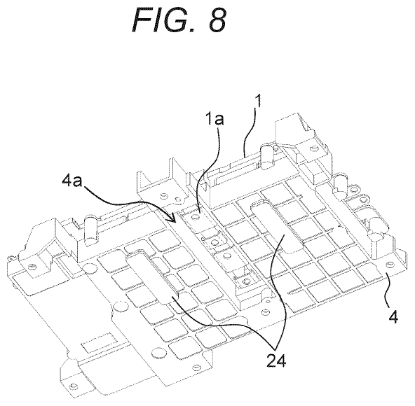

### (FIG. 8)

The case 4 is formed of a metal such as aluminum or iron, and is formed by casting such as aluminum die-casting, for example. The case 4 has a bottom portion and is formed in a bag shape with an open top. The bottom portion of the case 4 also has a cooling passage contact portion 24, which is a projection for thermally contacting the cooling passage 15 of the power module 9 via the heat conduction member 26.

By connecting the first DC busbar 1 and the case 4, the protrusion 1a provided in the first DC busbar 1 is fitted into the pit portion 4a provided in the case 4. As illustrated in FIG. 8, it can be seen that, because the pit portion 4a has a penetrating structure, the protrusion 1a is visible from the back surface of the case 4. As a result, as described above with reference to FIGS. 6 and 7, the first DC busbar 1 provided in the case 4 can be connected to the second DC busbar 6 via the protrusion 1a.

### (FIG. 9)

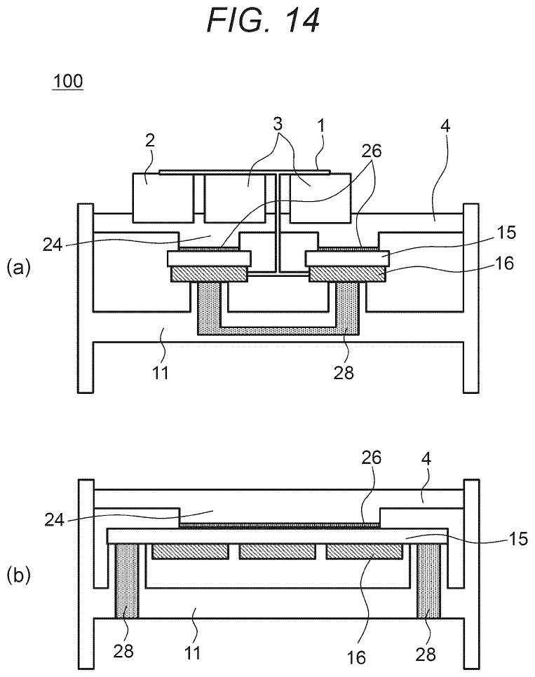

Inside the housing 11, the power module 9 to which the cooling passage 15 is attached is arranged horizontally with respect to the bottom portion. The power module 9 includes a semiconductor device 16 that converts DC power into AC power, and a pair of cooling passages 15 sandwiching the semiconductor device 16. The cooling passage 15 is not limited to being provided on both surfaces of the semiconductor device 16, and may be provided on only one surface of the semiconductor device 16 (described below with reference to FIG. 14).

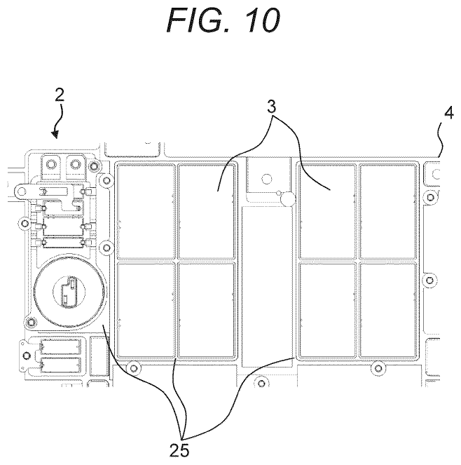

On the upper side of the power module 9 are arranged smoothing capacitors 3 configured by a combination of packages for each element, a first DC busbar 1 that includes a positive electrode busbar and a negative electrode busbar constituting a main circuit between the capacitor and the power module, and a case 4 which is a metal member for storing and fixing the smoothing capacitor 3 and the first DC busbar 1. A gap between the bottom surface of the inner plate of the case 4 and the housing 11 attached to the power module 9 and having a function of a passage formation body is filled with a resin heat conduction member 26 (described below with reference to FIG. 10) to thermally connect the case 4 and the power module 9. As a result, the smoothing capacitors 3 and the EMC filter 2 mounted on the metal case 4 are in indirect contact with the cooling passage 15 via the case 4 and the heat conduction member 26.

In addition, although the DC circuit body 5 unitized by the case 4 solves the problem from the viewpoint of assemblability, because the housing 11 and the case 4 are separated from each other, there is a problem in cooling performance, and there is a concern that degradation or destruction may occur due to self-heating of the EMC filter 2 and the smoothing capacitors 3, respectively, or due to scorching heat from an adjacent busbar. Therefore, as described above, by applying the configuration in which the case 4 and the cooling passage 15 on the upper surface of the power module 9 are thermally connected to each other by being contacted by the heat conduction member 26, the assemblability is not impaired, and the cooling performance is also improved.

Due to this configuration, the cooling performance is secured without impairing the heat dissipation of the components of the DC circuit body 5, and the assemblability is improved. Furthermore, it is also possible to suppress heat generation caused by shortening the busbar path in consideration of assemblability and for the purpose of reducing the main circuit inductance.

The gate drive substrate 10 is mounted with a heat generating component such as a transformer that converts high voltages. Meanwhile, because the housing 11 is a passage formation body through which a refrigerant for cooling the power module 9 flows, the temperature is low among the components constituting the inverter 100. Therefore, the gate drive substrate 10 and the housing 11 are thermally connected to each other while a gap therebetween is filled with a heat conduction member 26 (described below), which contributes to improving the cooling performance of the gate drive substrate 10. Further, reducing the risk of failure of the mounted component of the gate drive substrate 10 due to heat can contribute to improving reliability as the inverter 100 (described below with reference to FIG. 13).

### (FIG. 10)

A resin member (potting resin) 25 is filled between the first and second smoothing capacitor accommodating portions 4b and the filter accommodating portion 4c (see FIG. 4) of the case 4 and the plurality of smoothing capacitors 3 and the EMC filter 2.

The resin member 25 is a resin member having thermal conductivity and electrical insulation, and is cured by being filled between the accommodating components of the case 4 described above. Therefore, the relative positions of the accommodating components in the case 4 are fixed, and the resin member is indirectly thermally connected to the cooling conduit 15 of the power module 9, and the cooling performance is also improved. Although the filling rate of the resin member 25 with respect to the volume of the accommodating portions of the case 4 is not defined, the filling rate is preferably as high as possible from the viewpoint of cooling.

The accommodating components of the case 4 are fixed by the resin member 25; however, the present invention is not limited to this fixing method, rather, other methods such as fixing by screw fastening may also be used. In addition, the accommodating portions 4b and 4c included in the case 4 are not limited to being used as the accommodating portions 4b and 4c that accommodate the smoothing capacitors 3 and the EMC filter 2, and may have a function as accommodating portions for other components.

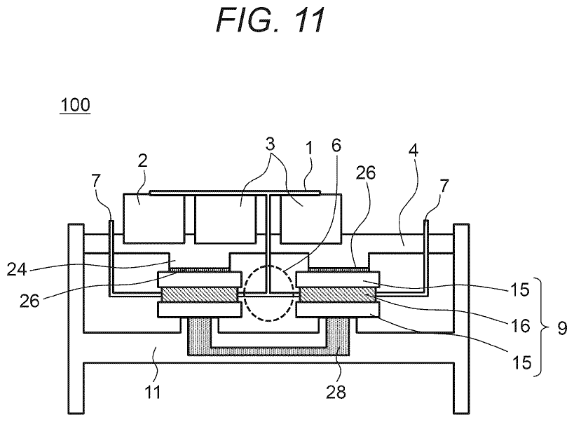

### (FIG. 11)

Because the components of the power conversion device 100 such as the power module 9 can be attached to the housing 11 from one direction (the upward direction in FIG. 11), rotation work is unnecessary, and assembly work is straightforward. Further, by configuring the cooling passage 15 on the power module 9 side, in which heat dissipation performance is emphasized, and the DC circuit body 5, in which customizability in accordance with the strength and specifications as the case 4 is emphasized, as separate components, it is possible to achieve both standardization of the components in the device 100 and improvement of the degree of freedom in optimal layout design.

The case 4, which is a metal accommodating member, is connected to the power module 9 in which the semiconductor device 16 and the cooling passage 15 are integrated via the heat conduction member 26 at the cooling passage contact portion 24 provided on the bottom surface. The power module 9 faces the first DC busbar 1, the EMC filter 2, and the smoothing capacitors 3 with the case 4 interposed therebetween.

As a result, conventionally, because components such as the EMC filter 2 and the smoothing capacitors 3 are mounted in the same space, there is a problem in heat dissipation efficiency because such components are mainly affected by the heat of the power module 9. However, because the DC circuit body 5 and the power module 9 can be separated from each other by using the case 4 according to the present invention, assemblability is maintained and heat dissipation is not impaired.

The power module 9 connected to a motor 200 (illustrated below in FIG. 12) mainly used for driving and power generation is disposed in the inverter 100. The power module 9 is connected to the first DC busbar 1 via the second DC busbar 6. That is, the smoothing capacitors 3 and the EMC filter 2 are electrically connected to the semiconductor device 16 via the DC busbars 1 and 6.

The first DC busbar 1 and the second DC busbar 6 are wired using a space between the two power modules 9. As described above, in the first DC busbar 1, the first and second smoothing capacitor accommodating portions 4b are arranged on both sides of the pit portion 4a of the case 4, respectively. Due to this configuration, because the busbar path connected from the smoothing capacitors 3 to the power module 9 can be made shorter than conventionally, an increase in the inductance of the main circuit can be suppressed. Together with this advantageous effect, an increase in surge voltage due to switching of the power module 9 and the risk of damage due to an excessive withstand voltage of the components (EMC filter 2, smoothing capacitors 3) of the power conversion device 100 can also be reduced, which can contribute to improving the reliability of the power conversion device 100.

The housing 11 serves as a passage formation body forming a passage to form a cooling passage 28, and connects the cooling passage 28 to the cooling passage 15 of the power module 9 to circulate the refrigerant therein. Further, a DC connector (not illustrated) connected to a high-voltage cable 106 (described below in FIG. 12) connected to the high-voltage battery 101 is attached to the housing 11, and is electrically connected to the first DC busbar 1, the EMC filter 2, the smoothing capacitors 3, and the case 4, which are components of the DC circuit body 5 via a separate connection busbar (not illustrated), whereby DC power is supplied to the power conversion device 100. Note that the form of connection with the high-voltage battery 101 is not limited to the foregoing connection.

### (FIG. 12)

The three-phase inverter circuit 110 included in the inverter 100 is connected in parallel with the battery 101 and the smoothing capacitors 3, and is supplied with DC power from the battery 101. The DC power is smoothed by the smoothing capacitors 3 connected in parallel. The smoothed DC power is converted into AC power by the semiconductor device 16 and outputted to the motor 200.

The three-phase inverter circuit 110 includes a three-phase one-leg inverter 108 that integrates the semiconductor device 16 and the control circuit 10 (gate drive substrate 10), and outputs a three-phase alternating current to the motor 200 by performing respective switching between ON and OFF. In FIG. 12, only one phase of the three-phase one-leg inverter 108 is illustrated, and illustration of the other two phases is omitted.

The current flowing through the upper arm element 23a and the lower arm element 23b of the semiconductor device 16 is controlled by performing the foregoing switching between ON and OFF by means of a control signal outputted from the control circuit 10. Thus, the DC power is converted into AC power. The control signal outputted from the control circuit 10 is inputted to each of the upper arm element 23a and the lower arm element 23b through the signal wiring and the gate resistor 105.

The semiconductor device 16 includes a switching element and a diode such as an insulated gate bipolar transistor (IGBT) operating as an upper arm, and a switching element and a diode such as an IGBT operating as a lower arm.

The three-phase semiconductor device 16 is connected in parallel to the high-voltage side input wiring 106 and the low-voltage side input wiring 107, respectively. Further, the three-phase inverter circuit 110 is connected to the three-phase stator winding 200a of the motor 200 at an intermediate point connected in series with each of the upper arm semiconductor element 23a and the lower arm semiconductor element 23b.

The three-phase semiconductor device 16 is connected in parallel to the high-voltage side input wiring 106 and the low-voltage side input wiring 107, and further includes signal wiring of the semiconductor device 16, a signal wiring board (not illustrated), and a control circuit 10, and hence the upper arm semiconductor element 23a and the lower arm semiconductor element 23b are each controlled by signal inputs from the control circuit 10 via the signal wiring, and thus functions as a three-phase inverter circuit 110 which is an electric circuit device. Furthermore, the motor output terminal (not illustrated) is connected to the three-phase stator winding 200a of the motor 200, the smoothing capacitors 3 are connected to the high-voltage side input wiring 106 and the low-voltage side input wiring 107, and the battery 101 is connected to a DC voltage input terminal (not illustrated), and hence the inverter 100 for converting DC power into AC power functions.

The smoothing capacitors 3 are connected between the high-voltage battery 101 and the semiconductor device 16, smooths DC power, and supply the smoothed DC power to the semiconductor device 16. A plurality of smoothing capacitors 3 packaged for each single element are mounted, but a plurality of elements may be incorporated into one package.

### First Modification

### (FIG. 13)

FIG. 13 is a diagram in which the gate drive substrate 10 and the MC substrate 12 are mounted in the embodiment disclosed with reference to FIG. 11. The MC substrate 12 transmits a control signal to the gate drive substrate 10 in order to control the operation of the motor 200. The gate drive substrate 10 transmits a drive control signal to the power module 9 on the basis of a signal from the MC substrate 12. The gate drive substrate 10 and the MC substrate 12 are arranged to face the smoothing capacitors 3 with the power module 9 interposed therebetween, and are supported by the housing 11 by being thermally connected to the housing 11 via the heat conduction member 26.

The housing 11 is connected to ground potential as described above. The case 4 is electrically connected to the housing 11. The housing 11 has a wall surface disposed between the power module 9 and the gate drive substrate 10. Therefore, the housing 11 functions as a shield that absorbs noise from the power module 9, reduces the risk of malfunction of the gate drive substrate 10, and contributes to improving the reliability of the inverter 100.

The MC substrate 12 is supported by the housing 11 by being thermally connected to the housing 11 via the heat conduction member 26. As a result, the temperature of the housing 11 including the cooling passage 15 for cooling the power module 9 is lowered, and thus the MC substrate 12 can be cooled. A processor such as a central processing unit (CPU) is mounted on the MC substrate 12, and the CPU generates heat when the inverter 100 is driven. Therefore, cooling reduces a risk of failure due to heat of substrate-mounted components such as the CPU, and contributes to improving the reliability of the inverter 100.

### Second Modification

### (FIG. 14)

FIG. 14(a) is a front view of a modification of the inverter 100, and FIG. 14(b) is a side view of the modification of the inverter 100. As illustrated in FIGS. 14(a) and 14(b), the present invention can also be applied to a case where the cooling conduit 15 of the power module 9 is disposed on one side instead of both sides in the inverter 100.

Although the present invention has been described as above, not only is it possible to afford the above-described advantageous effects, but also component standardization across models can be handled. In the above description, the dual-type power modules 9 that control the inputs and outputs of the two motors 200 are arranged in parallel. However, the present invention is not limited to or by this layout method.

The above-described embodiment of the present invention affords the following operational effects.

(1) The power conversion device 100 is equipped with a power module 9 having a semiconductor device 16 that converts DC power into AC power and a cooling passage 15 that cools the semiconductor device 16. In addition, the power conversion device 100 includes a metal accommodating member 4 a bottom surface of which is thermally connected to the cooling passage 15 via the heat conduction member 26, and the accommodating member 4 accommodates a plurality of smoothing capacitors 3 for smoothing the DC power. The plurality of smoothing capacitors 3 are electrically connected to the semiconductor device 16 via DC busbars 1 and 6 that are connected to the semiconductor device 16 and that input DC power to the semiconductor device 16. Due to this configuration, it is possible to provide a power conversion device 100 that achieves both an improvement in assemblability and maintenance of device heat dissipation.

(2) The power module 9 includes a first power module having a three-phase AC output and a second power module having a three-phase AC output independent of the first power module, and the DC busbar 6 passes through a space between the first power module and the second power module. Due to this configuration, because the busbar path connected from the smoothing capacitors 3 to the power module 9 can be made shorter than conventionally, an increase in the inductance of the main circuit can be suppressed.

(3) The accommodating member 4 includes first and second smoothing capacitor accommodating portions 4b that accommodate the plurality of smoothing capacitors 3, and a pit portion 4a through which the DC busbar 1 penetrates the accommodating member 4, and the first and second smoothing capacitor accommodating portions 4b are arranged with the pit portion 4a interposed therebetween. Due to this configuration, arrangement is possible without impairing the assemblability only by installing the accommodating member 4.

(4) The power conversion device 100 further includes a noise filter 2 that is electrically connected to the smoothing capacitors 3 and the semiconductor device 16 via the DC busbars 1 and 6 and removes radio frequency noise from the DC power. The accommodating member 4 includes a filter accommodating portion 4c that accommodates the noise filter 2, and the first and second smoothing capacitor accommodating portions 4b that accommodate the smoothing capacitors 3. Due to this configuration, components of a DC circuit body 5 can be arranged without impairing the assemblability.

(5) Resin members 25 are filled between the filter accommodating portion 4c and the noise filter 2 and between the first and second smoothing capacitor accommodating portions 4b and the plurality of smoothing capacitors 3, respectively. Due to this configuration, the relative positions of the accommodating components of the case 4 are fixed, and the cooling performance is also improved.

(6) The noise filter 2 includes the DC busbar that transmits the DC power, a magnetic core member 23 disposed so as to surround the DC busbar, and a filter capacitor connected to the DC busbar. The DC busbar has a positive electrode busbar 19 and a negative electrode busbar 20, and the filter capacitor has a first filter capacitor 21 and a second filter capacitor 22. The first filter capacitor 21 has one end connected to the positive electrode busbar 19 and the other end connected to the negative electrode busbar 20, and the second filter capacitor 22 has one end connected to either the positive electrode busbar 19 or the negative electrode busbar 20 and the other end grounded to ground potential. Due to this configuration, in the power conversion device 100, the electromagnetic noise generated at the time of the power conversion operation (at the time of switching) of the power module 9 is suppressed.

(7) The power conversion device 100 includes a gate drive substrate 10 that sends a control signal to the semiconductor device 16; and a housing 11 that is a passage formation body forming the cooling passage, wherein the gate drive substrate 10 is arranged to face the plurality of smoothing capacitors 3 with the power module 9 interposed between the gate drive substrate 10 and the plurality of smoothing capacitors 3, and the gate drive substrate 10 is supported by the housing 11 by being connected to the housing 11 by the heat conduction member 26. Due to this configuration, it is possible to contribute to improving the cooling performance of the gate drive substrate 10, and to contribute to improving reliability as the power conversion device 100 by reducing the risk of a component mounted on the gate drive substrate 10 failing due to heat.

(8) An electronic control board 12 that controls the operation of the motor 200 driven by the AC power is further provided. The housing 11 is connected to ground potential, and the accommodating member 4 is electrically connected to the housing 11. The electronic control board 12 is arranged to face the plurality of smoothing capacitors 3 with the power module 9 interposed between the electronic control board 12 and the plurality of smoothing capacitors 3, and is arranged to face the power module 9 with the housing 11 interposed therebetween, and the electronic control board 12 is supported by the housing 11 by being connected to the housing 11 by the heat conduction member 26. Due to this configuration, the MC substrate 12 is cooled via the housing 11 connected to the cooling passage 15, and the risk of failure due to heat from substrate-mounted components such as a CPU on the MC substrate 12 is reduced, which contributes to improving the reliability of the power conversion device 100.

Note that the present invention is not limited to or by the above embodiments, and various modifications and other configurations can be combined within a scope not departing from the spirit of the present invention. In addition, the present invention is not limited to embodiments which include all the configurations described in the above embodiment, and includes embodiments in which a portion of the configurations is deleted.

### REFERENCE SIGNS LIST

1 first DC busbar
1a protrusion
2 EMC filter (noise filter)
3 smoothing capacitor
4 DC circuit storage member (case)
4a pit portion
4b (first and second) smoothing capacitor accommodating portion
4c filter accommodating portion
5 DC circuit module (DC circuit body)
6 second DC busbar (power module connection side)
7 AC busbar
7a L-shaped AC busbar
8 AC current sensor
9 power module unit
10 gate drive substrate
11 housing (passage formation body)
12 MC (Motor Control) substrate
13 cover
14 DC connector
15 cooling passage (power module side)
16 semiconductor device
17 grounding busbar
18 molded busbar
19 positive electrode busbar
20 negative electrode busbar
21 first filter capacitor
22 second filter capacitor
23 core member
24 cooling passage contact portion
25 resin member (potting resin)
26 heat conduction member
27 heat transfer
28 cooling passage
100 power conversion device

1. A power conversion device equipped with a power module having a semiconductor device that converts DC power into AC power and a cooling passage that cools the semiconductor device, the power conversion device comprising
a metal accommodating member a bottom surface of which is thermally connected to the cooling passage via a heat conduction member,
wherein the accommodating member accommodates a plurality of smoothing capacitors for smoothing the DC power, and
the plurality of smoothing capacitors are electrically connected to the semiconductor device via a DC busbar that is connected to the semiconductor device and that inputs the DC power to the semiconductor device.

2. The power conversion device according to claim 1,
wherein the power module includes a first power module having a three-phase AC output and a second power module having a three-phase AC output independent of the first power module, and
the DC busbar passes through a space between the first power module and the second power module.

3. The power conversion device according to claim 2,
wherein the accommodating member includes first and second smoothing capacitor accommodating portions that accommodate the plurality of smoothing capacitors, and a pit portion through which the DC busbar penetrates the accommodating member, and
the first and second smoothing capacitor accommodating portions are arranged with the pit portion interposed therebetween.

4. The power conversion device according to claim 1, further comprising
a noise filter that is electrically connected to the smoothing capacitors and the semiconductor device via the DC busbar and that removes radio frequency noise from the DC power,
wherein the accommodating member includes a filter accommodating portion that accommodates the noise filter, and the first and second smoothing capacitor accommodating portions that accommodate the plurality of smoothing capacitors.

5. The power conversion device according to claim 4,
wherein resin members are filled between the filter accommodating portion and the noise filter and between the first and second smoothing capacitor accommodating portions and the plurality of smoothing capacitors, respectively.

6. The power conversion device according to claim 4,
wherein the noise filter includes the DC busbar that transmits the DC power, a magnetic core member disposed so as to surround the DC busbar, and a filter capacitor connected to the DC busbar,
the DC busbar has a positive electrode busbar and a negative electrode busbar,
the filter capacitor has a first filter capacitor and a second filter capacitor, and
the first filter capacitor has one end connected to the positive electrode busbar and another end connected to the negative electrode busbar, and the second filter capacitor has one end connected to either the positive electrode busbar or the negative electrode busbar and another end grounded to ground potential.

7. The power conversion device according to claim 1, further comprising:
a gate drive substrate that sends a control signal to the semiconductor device; and
a housing that is a passage formation body forming the cooling passage,
wherein the gate drive substrate is disposed to face the plurality of smoothing capacitors with the power module interposed between the gate drive substrate and the plurality of smoothing capacitors, and
the gate drive substrate is supported by the housing by connecting the gate drive substrate to the housing by means of the heat conduction member.

8. The power conversion device according to claim 7, further comprising
an electronic control board that controls operation of a motor driven by the AC power,
wherein the housing is connected to ground potential,
the accommodating member is electrically connected to the housing,
the electronic control board is disposed facing the plurality of smoothing capacitors with the power module interposed therebetween, and is disposed facing the power module with the housing interposed therebetween, and
the electronic control board is supported by the housing by connecting the electronic control board to the housing by means of the heat conduction member.
